(19) United States
(12) Patent Application Publication
(10) Pub. No.: US 2025/0258112 A1
(43) Pub. Date: Aug. 14, 2025

(54) SYSTEMS AND METHODS FOR DETECTING DEFECTS IN MATERIALS

(71) Applicant: Intuitive Research and Technology Corporation, Huntsville, AL (US)

(72) Inventors: Charles Thomas ETHEREDGE, Huntsville, AL (US); Chandler Tate FOSTER, Harvest, AL (US); Michael Lee YOHE, Meridianville, AL (US); Steven Michael THOMAS, Madison, AL (US); Paul Michael COLLINS, Madison, AL (US)

(21) Appl. No.: 19/045,270

(22) Filed: Feb. 4, 2025

Related U.S. Application Data
(60) Provisional application No. 63/551,397, filed on Feb. 8, 2024.

(51) Int. Cl. G01N 23/046; G06T 7/00; G06T 11/00

(52) U.S. Cl. CPC G01N 23/046; G06T 7/0004; G06T 11/005; G01N 2223/419

(57) ABSTRACT

A system for facilitating detection of defects in materials is configurable to: (i) access a set of input images comprising a plurality of cross-sectional images providing a representation of a component; and (ii) process the set of input images using an off-nominal anomaly detection model by, for each particular cross-sectional image of the plurality of cross-sectional images: (a) generate a set of patch embedding vectors comprising a patch embedding vector for each image patch of the particular cross-sectional image; (b) generate a set of difference metrics based on the set of patch embedding vectors and a probabilistic representation of a nominal component; and (c) determine a set of anomaly scores for the particular cross-sectional image based on the set of difference metrics.

### CROSS-REFERENCE TO RELATED APPLICATIONS

This application claims priority to and the benefit of U.S. Provisional Patent Application No. 63/551,397, filed on Feb. 8, 2024, and entitled “SYSTEMS AND METHODS FOR DETECTING DEFECTS IN MATERIALS”, the entirety of which is incorporated herein by reference for all purposes.

### BACKGROUND

Various industries, such as aerospace, automotive, energy, medical devices, etc., utilize components in which performance, reliability, integrity and/or safety is critical. Rigorous quality control processes are often implemented to ensure that such critical components meet specifications. In some instances, a single scratch, delamination, crack, or other defect found during the quality control process can result in the component being deemed defective and unusable. Quality control processes can facilitate identification of defects early in the production process to minimize the likelihood of costly rework.

Nondestructive testing (NDT) includes methods for measuring the quality and/or integrity of manufactured components without causing harm to them or altering their structure. NDT includes various types of processes, such as ultrasonic testing, magnetic particle testing, liquid penetrant testing, eddy current testing, acoustic emission testing, radiographic testing, and others. Radiographic testing utilizes x-rays, gamma rays, or other radiation to examine internal and/or external features of a component. The radiation passes through the material and is detected after interaction with the material, giving rise to a radiographic image that captures the variations in density of the material. Radiographic testing can enable detection of issues like cracks, voids, delaminations, porosity issues, and/or others.

The subject matter claimed herein is not limited to embodiments that solve any challenges or that operate only in environments such as those described above. Rather, this background is only provided to illustrate one exemplary technology area where some embodiments described herein may be practiced.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a conceptual representation of training an off-nominal anomaly detection model using training images of a manufactured component.

FIG. 2 illustrates a conceptual representation of using off-nominal anomaly detection models to obtain anomaly scores for input imagery capturing a manufactured component.

FIG. 3 illustrates a conceptual representation of an example user interface frontend that can facilitate review of image slices determined via an off-nominal anomaly detection model to include defects in a manufactured component.

FIGS. 4 and 5 depict flow diagrams depicting acts associated with the disclosed subject matter.

FIG. 6 illustrates an example system that may comprise or implement one or more disclosed embodiments.

### DETAILED DESCRIPTION

Disclosed embodiments are directed to systems, methods, devices, and/or techniques for detecting defects in materials.

As noted above, radiographic testing is a type of NDT that involves emitting radiation through a manufactured component to form images of the component, enabling detection of defects in the component. One type of radiographic NDT utilizes computed tomography (CT) imaging, which provides detailed cross-sectional images of the component's internal structure. CT imaging involves emitting beams of X-rays through a component toward a detector at different angles/positions. Detected X-rays are attenuated by passing through the various parts of the component, and the amount of attenuation is based on the properties of the component passed through. The detected X-rays can be used to construct cross-sectional images of the component that enable visualization of the internal features, voids, and/or defects of the component. Often, CT imaging of a component involves acquisition of cross-sectional images of the component in multiple orthogonal planes (e.g., a median or sagittal plane, a frontal or coronal plane, and a horizontal or transverse plane).

Defect detection via CT imaging is associated with numerous challenges. For instance, analysis of CT images to detect component defects is often time-consuming and expensive, relying on specialized radiographers with further specialized knowledge relating to the manufactured components under analysis. Human review of the CT images can give rise to various errors due to human subjectivity, such as failure to detect defects when such defects are present, false positive detections (e.g., when “mimics” are determined to be defects), etc. A typical set of cross-section CT images of a manufactured component can include thousands of images (e.g., 7,800 DICOM images, including 2,600 per axis). Using current techniques, adequate review of CT images for a single component (in some domains) can take weeks, which is unsustainable for high production rates.

At least some disclosed embodiments are directed to computer vision techniques for detecting defects represented in cross-sectional images of components (e.g., manufactured components). Disclosed embodiments utilize an off-nominal anomaly detection framework for model training and anomaly detection. Such techniques involve training one or more models (referred to as “off-nominal anomaly detection models”) to analyze the cross-sectional images (e.g., “slices”) of each axis (e.g., median, frontal, and horizontal) of cross-sectional image sets to flag the slices that are off-nominal (or that include off-nominal image information). The flagging may indicate image slices (e.g., in each of the different axes) determined to represent defects in the components captured by the cross-sectional image sets. Defect locations may also be determined within the flagged slices, such as by constructing a heat map for each flagged image slice that indicates the likely location of an anomaly or defect.

Various reports and/or user interface components may be generated and/or presented based on the flagged image slices and/or the locations of the defects within the flagged image slices. For instance, an indication of the flagged image slices (in the various axes) determined to show potential component defects may be compiled in a report or presented to a user on a user interface, enabling the user to review the flagged image slices and the proposed defects represented therein. At the user interface, the user may indicate whether the proposed defects represented in the flagged image slices correspond to actual defects or not. The user input accepting or rejecting the defect proposals may be used to further train/refine the off-nominal anomaly detection model(s) (e.g., by refining the training dataset to include additional samples showing certain areas of the component). A user accepting a proposed defect as an actual defect may trigger corrective action on the particular component that includes the defect (e.g., identifying the particular component as defective in a database, isolating or quarantining the particular component, preventing the particular component from proceeding to a production environment, triggering rework or remanufacture, etc.). In some implementations, when a proposed defect is accepted as an actual defect, the user may provide additional input classifying the defect type of the proposed defect (e.g., crack, void, delamination, etc.), which can be used to train models for classifying defect proposals. Such defect classification models can operate in series with off-nominal anomaly detection models.

The techniques described herein may be applied to drastically reduce the search space of CT image sets of manufactured components for review by human inspectors, which can increase the speed and/or accuracy with which material defects can be identified.

Conventional computer vision detection models are trained on large sets of human-labeled images. For some models, labeled sets of thousands of images (e.g., 10,000 or more) are used for each feature to be learned by the model. In the current context of defect detection in components, using conventional computer vision detection model training techniques, one or more models would need to be trained on voluminous sets of labeled of images for each of the different types of defects of interest (e.g., cracks, voids, delaminations, etc.), which would enable the model(s) to identify each type of defect at inference. Such conventional approaches would prove unsatisfactory for the task of defect detection in components as described herein at least because: (1) defects can be rare and are often visible in only a small percentage of slices from any given axis, (2) even for a defective component that includes one or more defects shown in some slices, the remaining slices (often the vast majority of the slices) for the defective component will typically appear non-defective, (3) a definitive and sufficiently large dataset of image slices depicting defects would be difficult to construct (e.g., parsing thousands of image slices for a single defective component may only yield a few image slices showing a defect), and (4) due to the variations in the types of defects and the characteristics that they can embody, it is impractical to compile a labeled dataset of all possible defect types to be identified at inference.

Accordingly, the techniques described herein utilize an off-nominal anomaly detection framework for model training and anomaly detection at inference. Such techniques involve training one or more off-nominal anomaly detection models to understand an expected distribution of features in normal, non-anomalous images (e.g., nominal images). Once trained, the model(s) can be used to detect anomalies or deviations (e.g., off-nominal image patches) from the learned distribution in new, unseen data. Because such off-nominal anomaly detection model(s) can operate under a binary goal (e.g., identifying a given patch of pixels as either nominal or off-nominal), the training dataset used to train the model(s) can be much smaller than datasets used to train conventional computer vision detection models. In one example, a training dataset used to train an off-nominal anomaly detection model can include a quantity of images on the order of hundreds, rather than thousands. The training dataset for training an off-nominal anomaly detection model can include a set of images (e.g., a normally distributed set of images) that provides a nominal representation of a component (e.g., without defects).

Although examples described herein focus, in at least some respects, on utilizing CT images to capture a component, other cross-sectional imaging modalities are within the scope of the present disclosure.

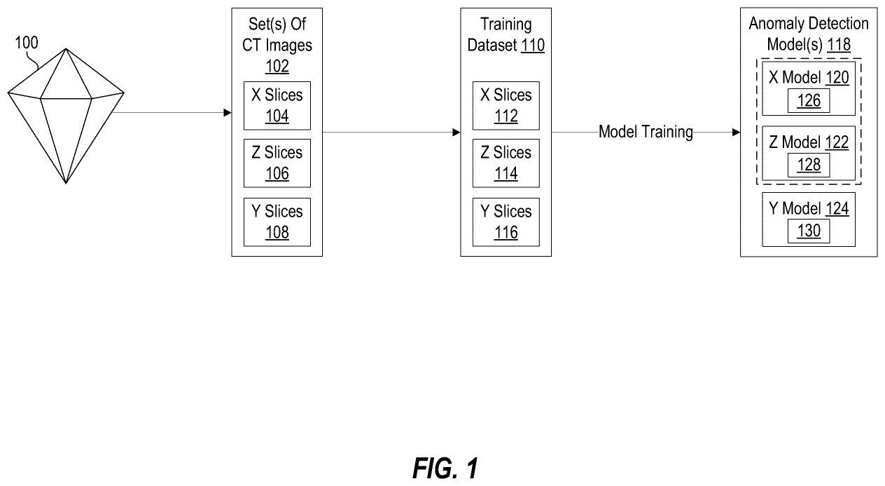

FIG. 1 provides a conceptual representation of training an off-nominal anomaly detection model, in accordance with implementations of the disclosed subject matter. FIG. 1 illustrates a type of component 100 (e.g., a diamond-shaped object, depicted from a perspective view) on which CT imaging is performed to obtain one or more sets of CT images 102 of the component 100. The set(s) of CT images 102 of FIG. 1 each include cross-sectional images (or “image slices”) of the component 100 from multiple cross-section orientations. For instance, the set(s) of CT images 102 of FIG. 1 each include x-axis image slices 104 (or median image slices), z-axis image slices 106 (or frontal image slices), and y-axis image slices 108 (or horizontal image slices). In some instances, the set(s) of CT images 102 include multiple subsets of CT images that capture different copies or instances of the component 100.

FIG. 1 furthermore depicts a training dataset 110 constructed based on the set(s) of CT images 102 (e.g., where the set(s) of CT images 102 serve as an initial set of cross-sectional images used to construct the training dataset 110). The training dataset 110 can include image slices selected from the set(s) of CT images 102 that provide a nominal representation of the component 100 (e.g., a representation of the component 100 that lacks defects). Similar to the set(s) of CT images 102, the training dataset 110 of FIG. 1 can include x-axis slices 112, z-axis slices 114, and y-axis slices 116, providing nominal representations of the component 100 from different slice orientations. The image slices of the training dataset 110 may be selected or sampled from the set(s) of CT images 102 in various ways, such as via manual selection (e.g., ensuring slices that include defects are omitted from the training dataset 110), systematic sampling methods (e.g., selecting every Nth slice from one or more CT image sets; taking N slices, skipping a quantity of slices, then taking another N slices), random sampling, sampling based on changes from slice to slice (e.g., based on changes in the representation of the component 100 from slice to slice, such as changes in color, changes in size/shape, etc., where selection rate can be based on level of change from slice to slice), sampling based on comparisons between slices of different CT image sets at the same slice location/position (e.g., sampling from slices determined to be similar to other slices at common locations or imaging positions in other CT image sets), and/or others.

In some implementations, the x-axis slices 112, the z-axis slices 114, and/or the y-axis slices 116 are each configured with a normal distribution of image slices associated with each different region of the component 100. For instance, the x-axis slices 112 can include a similar quantity of image slices representing each different physical section of the component 100. Notwithstanding, the x-axis slices 112, the z-axis slices 114, and/or the y-axis slices 116 can include image slices from multiple different sets of CT images that capture the same component 100. In this regard, slices of a particular section of the component 100 that do not show defects can be selected for inclusion in the training dataset 110 rather than slices from the same section of the component from other CT image sets that show defects.

FIG. 1 conceptually depicts the performance of model training using the training dataset 110 to obtain off-nominal anomaly detection model(s) 118 (indicated in FIG. 1 by the arrow labeled “Model Training” extending from training dataset 110 to off-nominal anomaly detection model(s) 118). The off-nominal anomaly detection model(s) 118 can include any quantity of models. For example, FIG. 1 illustrates the off-nominal anomaly detection model(s) 118 as including an x-axis model 120 trained using the x-axis slices 112, a z-axis model 122 trained using the z-axis slices 114, and a y-axis model 124 trained using the y-axis slices 116. In some circumstances, the off-nominal anomaly detection model(s) 118 can include models trained to perform off-nominal anomaly detection for image slices of multiple axes, such as where the component 100 is symmetric in two or more axes. For instance, the component 100 could be symmetric in the x and z axes, allowing a single off-nominal anomaly detection model to be trained on both the x-axis slices 112 and the z-axis slices 114 (e.g., the x-axis model 120 and the z-axis model 122 may comprise a single model, as indicated in FIG. 1 by the dashed box surrounding the two). Other instances of exploiting symmetry of the component 100 to train fewer models for the off-nominal anomaly detection model(s) 118 are within the scope of the present disclosure, such as where the x and y axes are symmetric, or the z and y axes are symmetric, or the x, y, and z axes are symmetric (resulting in a single model).

The model training for each of the off-nominal anomaly detection model(s) 118 may comprise utilizing an embedding model to generate image patch embedding vectors for image patches from the corresponding image slices of the training dataset 110. The patch embedding vectors can operate as features that represent normal or nominal characteristics for patches of pixels depicting various regions of the component 100. The patch embedding vectors may be used to construct a probabilistic representation of a nominal component (e.g., a nominal representation of the component 100). FIG. 1 depicts each of the x-axis model 120, z-axis model 122, and y-axis model 124 as including a respective probabilistic representation 126, 128, and 130 of a nominal component. Although examples herein focus on constructing probabilistic representations using patch embedding vectors, other techniques for constructing probabilistic representations for regions of a component 100 may be used, such as pixel-level probabilistic modeling, end-to-end probabilistic modeling, global feature-based probabilistic representations, energy models, probabilistic principal component analysis, neural networks/machine learning, and/or others.

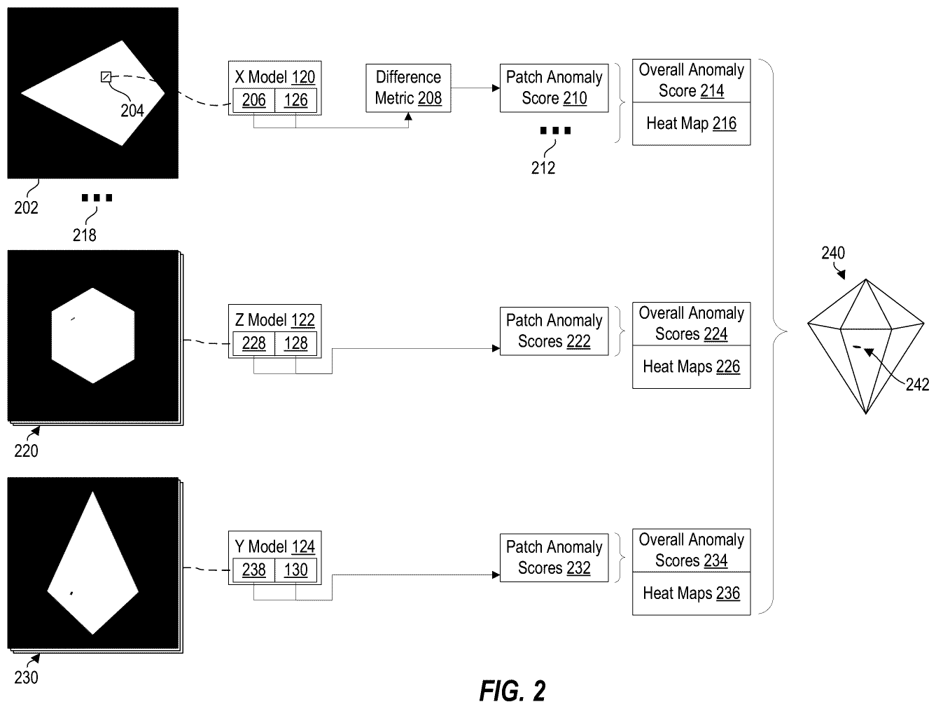

After model training, to perform inference, the off-nominal anomaly detection model(s) 118 can utilize the learned probabilistic representation of the nominal component 100 to identify anomalies in input imagery (e.g., input image slices depicting the same type of component 100 used to generate the training dataset 110). FIG. 2 provides a conceptual representation of using the x-axis model 120 to determine an anomaly score based on an input image 202. The input image 202 of FIG. 2 is an x-axis cross-sectional image of the component 100 (with the black region indicating empty space). FIG. 2 depicts an image patch 204 of the input image 202, which is processed as input by the x-axis model 120. In the example of FIG. 2, the x-axis model 120 generates an input image patch embedding 206 based on the image patch 204 (e.g., using an embedding model) and determines a difference measurement 208 based on the input image patch embedding 206 and the learned probabilistic representation 126 of the nominal component 100 (at the same location). The difference measurement 208 can be used to determine a patch anomaly score 210 (e.g., a decimal number between 0 and 1), where a higher score indicates a greater chance that the patch represents off-nominal information (e.g., that the patch shows a defect in the component).

The ellipsis 212 of FIG. 2 indicates that patch anomaly scores can be determined for any quantity of patches of the input image 202. In some instances, the patch anomaly scores can be compared to one or more thresholds to determine whether the input image 202 or the patches thereof become flagged as likely including anomalies. The threshold(s) may be adjustable to accommodate different component types, defect tolerances, etc. Furthermore, in some implementations, an overall anomaly score 214 for the input image 202 may be determined based on the patch anomaly scores associated with the image (e.g., the highest patch anomaly score for patches of an input image may be defined as the overall anomaly score for the input image, or an aggregation or combination of patch anomaly scores). The overall anomaly score 214 for an image may indicate whether to flag the image as potentially depicting a defect (e.g., by comparison to one or more thresholds).

In some implementations, the anomaly scores for an input image are used to construct a heat map 216, in which image patches can be colorized or otherwise differentiated based on their patch anomaly scores. The heat map 216 can readily indicate to users the locations of potential anomalies within the cross-sectional images during user review. In some implementations, a workflow may be constructed that compiles heat maps and/or input images that include or are associated with one or more anomaly scores that satisfy a threshold, enabling users to quickly review heat maps and/or input images that may show defects. A user interface frontend may be provided that enables user to navigate among the compiled heat maps and/or input images, where presentations of input images and their corresponding heat maps may be shown simultaneously and/or selectively toggled.

The ellipsis 218 of FIG. 2 indicates that any quantity of x-axis input images (e.g., an entire set of x-axis cross-sectional images) may be processed by the x-axis model 120 to generate patch-level anomaly scores, overall anomaly scores, and/or heat maps. FIG. 2 furthermore illustrates z-axis input images 220 being processed via the z-axis model 122 (using input image patch embeddings 228 and the probabilistic representation 128) to obtain z-axis patch anomaly scores 222, overall anomaly scores 224, and heat maps 226, and FIG. 2 illustrates y-axis input images 230 being processed via the y-axis model 124 (using input image patch embeddings 238 and the respective probabilistic representation 130) to obtain y-axis patch anomaly scores 232, overall anomaly scores 234, and heat maps 236. As noted above, the input images 202, 220, and 230 may comprise cross-sectional CT images, which may include DICOM or similar metadata. Accordingly, the input images 202, 220, and 230 may be used to digitally reconstruct a 3D representation of the component 100 represented in the input images 202, 220, and 230. FIG. 2 illustrates a 3D representation 240 of the component 100 constructed based on the input images 202, 220, and 230 of the component 100. The 3D representation 240 can be further constructed based on the patch anomaly scores 210, 222, and 232, the overall anomaly scores 214, 224, and 234, and/or the heat maps 216, 226, and 236 to enable visualization of the defects in the 3D representation 240 (if any). In the example of FIG. 2, a defect 242 is emphasized in the 3D representation 240, in which the defect 242 is identified by determining the voxels of the 3D representation 240 that are associated with image patches with patch anomaly scores that satisfy one or more conditions (e.g., thresholds).

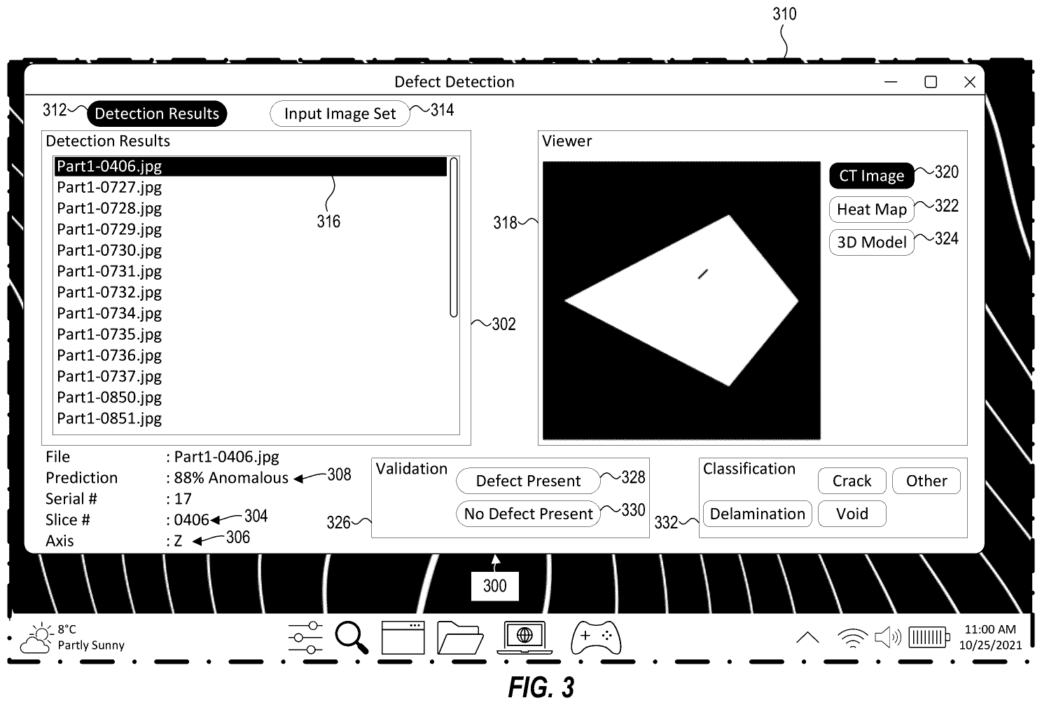

Input images 202, 220, or 230 that are associated with an overall anomaly score 214, 224, or 234 (or one or more patch anomaly scores) that satisfies one or more conditions (e.g., thresholds) may be flagged as showing anomalies in the imaged component 100. The flagged images (or their identifying information, such as slice number, image set identifier, etc.) may be used to generate a report, summary, or other presentation displayable on a user device. FIG. 3 depicts an example user interface fronted 300 shown on a display 310 (e.g., executable and/or presentable via one or more components of one or more systems 600 and/or remote systems 612). The user interface frontend 300 depicts anomaly detection results 302 showing a list of the flagged images. The user interface frontend 300 may additionally depict the original set of input image slices in navigable form. For instance, a user may toggle between viewing the anomaly detection results 302 and the original set of input images using selectable elements 312 and 314 of the user interface frontend 300 (other selection frameworks or modalities are possible).

In the example shown in FIG. 3, the user interface frontend 300 depicts a selected flagged image 316 from the list of anomaly detection results 302, which may be selected based on user input directed to the user interface frontend 300. For the selected flagged image 316, the user interface frontend 300 shown in FIG. 3 presents the slice number 304 and the axis 306 of the selected flagged image slice, as well as the overall anomaly score 308 therefor. Furthermore, in the example shown in FIG. 3, the user interface frontend 300 provides a viewer 318, which may display the selected flagged image 316, its corresponding heat map, and/or a 3D representation of the component represented in the input images (e.g., which may be shown simultaneously or togglable via selectable elements 320, 322, or 324 or other means).

In the example shown in FIG. 3, the user interface frontend 300 further provides validation functionality, enabling users to provide input to confirm whether a defect is represented in the selected flagged image 316 based on human review. For instance, user interface frontend 300 includes a validation window 326, enabling users to confirm that a defect is present (e.g., via selectable element 328) or that a defect is not present (e.g., via selectable element 330) in the selected flagged image 316. In some implementations, user input confirming that a defect is present for any flagged image slice associated with a particular component can trigger corrective action for the particular component (e.g., sending a notification, identifying or flagging the particular component as defective, isolating or quarantining the particular component, preventing the particular component from proceeding to a production environment, triggering rework or remanufacture, etc.). In some implementations, user input confirming whether a defect is present for a flagged image slice can be used to further train or fine-tune the off-nominal anomaly detection model(s) 118 (e.g., validation input from a user can be used to train the off-nominal anomaly detection model(s) 118 associated with the axis 306 of the selected flagged image 316).

In some implementations, the user interface frontend 300 can enable users to provide input classifying the defects represented in the flagged images, which can be used to train models for classifying defects identified in images via off-nominal anomaly detection model(s) 118. For instance, FIG. 3 illustrates an example in which the user interface frontend 300 includes a classification window 332, enabling users to select the type of defect present in a selected flagged image 316 (e.g., crack, void, delamination, or other).

In some implementations, the off-nominal anomaly detection model(s) 118 comprise a patch distribution modeling (PaDiM) framework, or a derivative or similar framework. An off-nominal anomaly detection model(s) 118 using a PaDiM framework can utilize a convolutional neural network (CNN) as an embedding model to determine patch embedding vectors (e.g., for determining the probabilistic representations 126, 128, or 130 during training, for determining the embeddings 206, 228, or 238 during inference). The CNN may comprise a pretrained CNN. In accordance with the PaDiM framework, the probabilistic representations 126, 128, and 130 may be defined as multivariate Gaussian distributions [symbol] (μᵢⱼ, Σᵢⱼ), wherein μᵢⱼ is the sample mean of the patch embedding vector at the patch position (i, j), and Iii is the sample covariance matrix and is estimated as:

$${\sum }_{ij} = \frac{1}{N - 1} {\sum }_{k = 1}^{N} ( {x}_{ij}^{k} - {μ}_{ij} ) {( {x}_{ij}^{k} - {μ}_{ij} )}^{T} + ϵ I$$

where N is the quantity of training images, xᵢⱼ is the patch embedding vector, and ϵI is a regularization term that makes the sample covariance matrix Σᵢⱼ full rank and invertible.

For inference, in accordance with the PaDiM framework, the difference metric 208 (and corresponding difference metrics for the other axes) may comprise a Mahalanobis distance, which may be regarded as the distance between the patch embedding of the input image and the embeddings of the nominal class that were learned during training (which are contained in the probabilistic representation [symbol] (μᵢⱼ, Σᵢⱼ)). The Mahalanobis distance may be defined as

$$M ( {x}_{ij} ) = \sqrt{{( {x}_{ij} - {μ}_{ij} )}^{T} {\sum }_{ij}^{- 1} ( {x}_{ij} - {μ}_{ij} )}$$

for a patch position (i, j).

Although at least some examples provided herein focus, in at least some respects, on utilizing a PaDiM framework to generate probabilistic representations using patch embeddings, other frameworks may be used, such as Gaussian mixture models, support vector data description, kernel density estimation, autoencoders, neural networks (e.g., transformers, Bayesian neural networks), combinations thereof, and/or others. Similarly, other types of difference metrics may be used to determine differences between patch embeddings of input images and the embeddings of nominal representation learned during training, such as Euclidean distance, Manhattan distance, cosine distance, Chebyshev distance, dot product, Jaccard similarity, Pearson correlation, probabilistic comparisons, and/or others.

### EXAMPLE METHOD(S)

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed. The various acts/operations described herein may be performed using one or more components of systems 600 and/or remote systems 612. In some embodiments, one or more of the acts described below may be omitted.

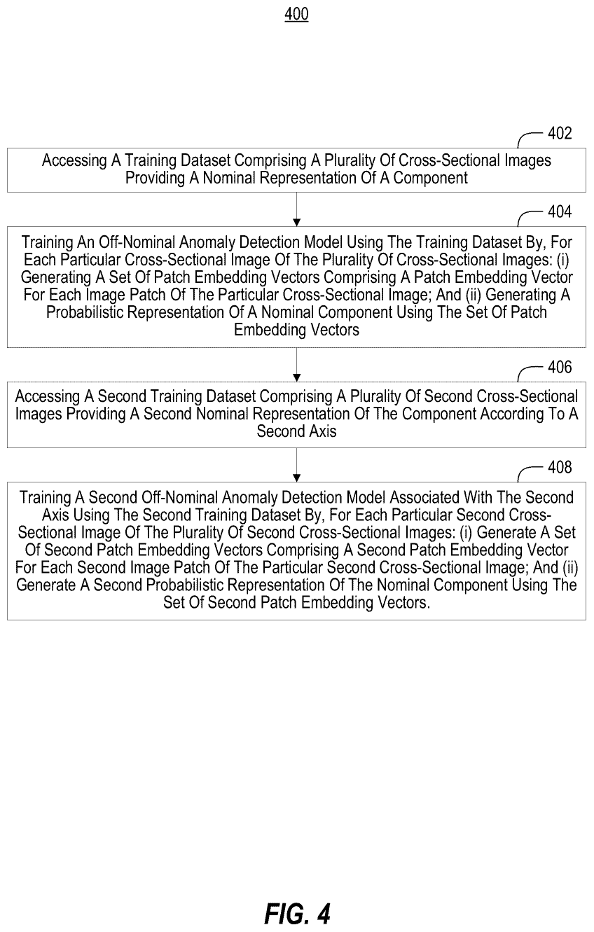

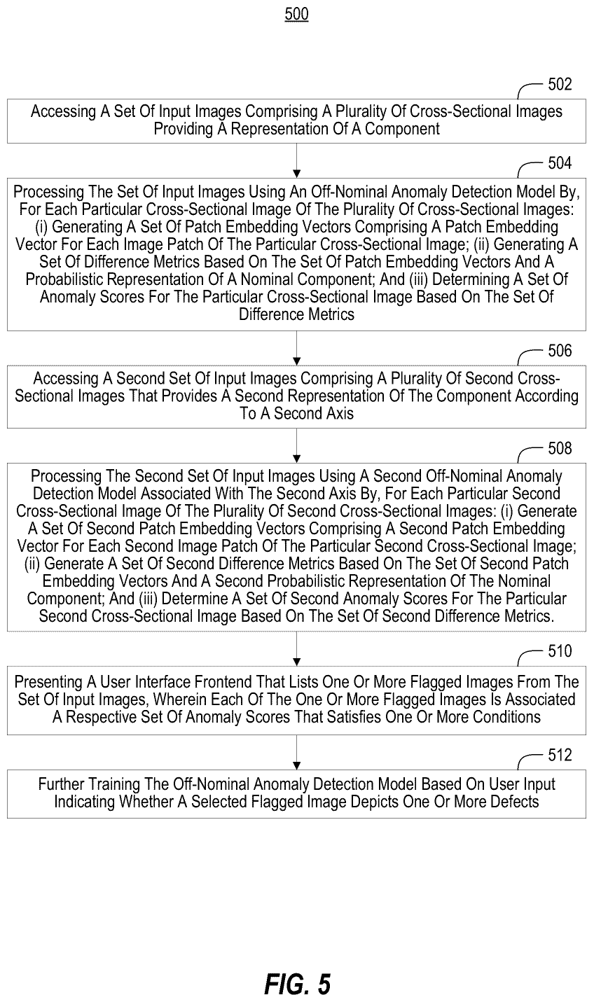

FIGS. 4 and 5 depict flow diagrams 400 and 500, respectively, depicting acts associated with the disclosed subject matter.

Act 402 of flow diagram 400 includes accessing a training dataset comprising a plurality of cross-sectional images providing a nominal representation of a component. In some instances, the plurality of cross-sectional images comprises a plurality of computed tomography (CT) images. In some implementations, the plurality of cross-sectional images comprises cross-sectional images selected or sampled from an initial set of cross-sectional images of the component. In some examples, the plurality of cross-sectional images omits one or more cross-sectional images from the initial set of cross-sectional images that show one or more defects. In some embodiments, the initial set of cross-sectional images includes a plurality of subsets of cross-sectional images, where each of the plurality of subsets of cross-sectional images depicts a different copy or instance of the component. In some instances, the plurality of cross-sectional images includes cross-sectional images from at least two subsets of cross-sectional images from the plurality of subsets of cross-sectional images.

Act 404 of flow diagram 400 includes training an off-nominal anomaly detection model using the training dataset by, for each particular cross-sectional image of the plurality of cross-sectional images: (i) generating a set of patch embedding vectors comprising a patch embedding vector for each image patch of the particular cross-sectional image; and (ii) generating a probabilistic representation of a nominal component using the set of patch embedding vectors.

In some implementations, the plurality of cross-sectional images provides the nominal representation of the component according to a first axis, and the off-nominal anomaly detection model is associated with the first axis. Act 406 of flow diagram 400 includes accessing a second training dataset comprising a plurality of second cross-sectional images providing a second nominal representation of the component according to a second axis. Act 408 of flow diagram 400 includes training a second off-nominal anomaly detection model associated with the second axis using the second training dataset by, for each particular second cross-sectional image of the plurality of second cross-sectional images: (i) generate a set of second patch embedding vectors comprising a second patch embedding vector for each second image patch of the particular second cross-sectional image; and (ii) generate a second probabilistic representation of the nominal component using the set of second patch embedding vectors.

Act 502 of flow diagram 500 includes accessing a set of input images comprising a plurality of cross-sectional images providing a representation of a component. In some instances, the plurality of cross-sectional images comprises a plurality of computed tomography (CT) images.

Act 504 of flow diagram 500 includes processing the set of input images using an off-nominal anomaly detection model by, for each particular cross-sectional image of the plurality of cross-sectional images: (i) generating a set of patch embedding vectors comprising a patch embedding vector for each image patch of the particular cross-sectional image; (ii) generating a set of difference metrics based on the set of patch embedding vectors and a probabilistic representation of a nominal component; and (iii) determining a set of anomaly scores for the particular cross-sectional image based on the set of difference metrics. In some implementations, the set of anomaly scores for the particular cross-sectional image comprises a respective patch anomaly score for each image patch of the particular cross-sectional image. In some examples, the set of anomaly scores for the particular cross-sectional image comprises an overall anomaly score based on one or more respective patch anomaly scores for each image patch of the particular cross-sectional image. In some embodiments, a heat map may be generated using the set of anomaly scores. In some instances, a 3D representation of the component may be generated using the plurality of cross-sectional images and the set of anomaly scores.

In some implementations, the plurality of cross-sectional images provides the representation of the component according to a first axis, and the off-nominal anomaly detection model is associated with the first axis. Act 506 of flow diagram 500 includes accessing a second set of input images comprising a plurality of second cross-sectional images that provides a second representation of the component according to a second axis. Act 508 of flow diagram 500 includes processing the second set of input images using a second off-nominal anomaly detection model associated with the second axis by, for each particular second cross-sectional image of the plurality of second cross-sectional images: (i) generate a set of second patch embedding vectors comprising a second patch embedding vector for each second image patch of the particular second cross-sectional image; (ii) generate a set of second difference metrics based on the set of second patch embedding vectors and a second probabilistic representation of the nominal component; and (iii) determine a set of second anomaly scores for the particular second cross-sectional image based on the set of second difference metrics.

Act 510 of flow diagram 500 includes presenting a user interface frontend that lists one or more flagged images from the set of input images, wherein each of the one or more flagged images is associated a respective set of anomaly scores that satisfies one or more conditions. In some instances, the one or more conditions comprise the respective set of anomaly scores including one or more overall anomaly scores or one or more patch anomaly scores that satisfy one or more thresholds. In some implementations, the user interface frontend is configured to receive user input indicating whether a selected flagged image depicts one or more defects.

Act 512 of flow diagram 500 includes further training the off-nominal anomaly detection model based on user input indicating whether a selected flagged image depicts one or more defects. In some examples, the user interface frontend is configured to receive user input classifying one or more defects present in a selected flagged image.

### Additional Details Related to Implementing the Disclosed Embodiments

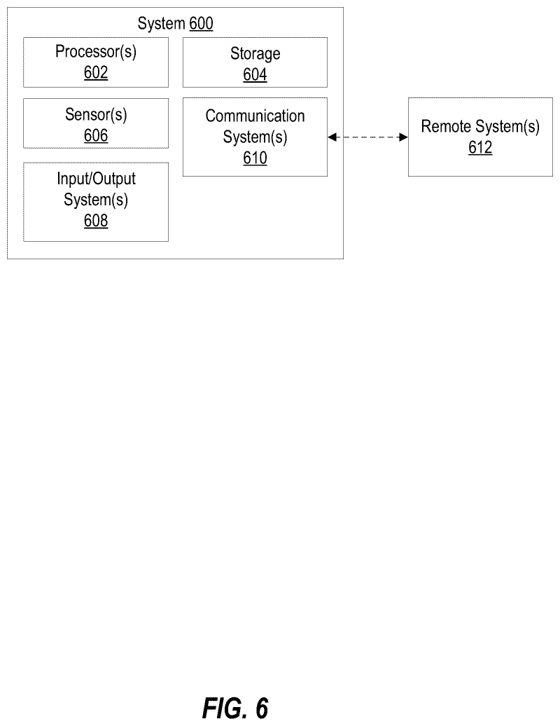

FIG. 6 illustrates example components of a system 600 that may comprise or implement aspects of one or more disclosed embodiments. For example, FIG. 6 illustrates an implementation in which the system 600 includes processor(s) 602, storage 604, sensor(s) 606, 1/O system(s) 608, and communication system(s) 610. Although FIG. 6 illustrates a system 600 as including particular components, one will appreciate, in view of the present disclosure, that a system 600 may comprise any number of additional or alternative components.

The processor(s) 602 may comprise one or more sets of electronic circuitries that include any number of logic units, registers, and/or control units to facilitate the execution of computer-readable instructions (e.g., instructions that form a computer program). Such computer-readable instructions may be stored within storage 604. The storage 604 may comprise physical system memory and may be volatile, non-volatile, or some combination thereof. Furthermore, storage 604 may comprise local storage, remote storage (e.g., accessible via communication system(s) 610 or otherwise), or some combination thereof. Additional details related to processors (e.g., processor(s) 602) and computer storage media (e.g., storage 604) will be provided hereinafter.

As will be described in more detail, the processor(s) 602 may be configured to execute instructions stored within storage 604 to perform certain actions. In some instances, the actions may rely at least in part on communication system(s) 610 for receiving data from remote system(s) 612, which may include, for example, separate systems or computing devices, sensors, and/or others. The communications system(s) 610 may comprise any combination of software or hardware components that are operable to facilitate communication between on-system components/devices and/or with off-system components/devices. For example, the communications system(s) 610 may comprise ports, buses, or other physical connection apparatuses for communicating with other devices/components. Additionally, or alternatively, the communications system(s) 610 may comprise systems/components operable to communicate wirelessly with external systems and/or devices through any suitable communication channel(s), such as, by way of non-limiting example, Bluetooth, ultra-wideband, WLAN, infrared communication, and/or others.

FIG. 6 illustrates that a system 600 may comprise or be in communication with sensor(s) 606. Sensor(s) 606 may comprise any device for capturing or measuring data representative of perceivable phenomenon. By way of non-limiting example, the sensor(s) 606 may comprise one or more image sensors, microphones, thermometers, barometers, magnetometers, accelerometers, gyroscopes, and/or others.

Furthermore, FIG. 6 illustrates that a system 600 may comprise or be in communication with I/O system(s) 608. I/O system(s) 608 may include any type of input or output device such as, by way of non-limiting example, a display, a touch screen, a mouse, a keyboard, a controller, and/or others, without limitation.

Disclosed embodiments may comprise or utilize a special purpose or general-purpose computer including computer hardware, as discussed in greater detail below. Disclosed embodiments also include physical and other computer-readable recording media for carrying or storing computer-executable instructions and/or data structures. Such computer-readable recording media can be any available media that can be accessed by a general-purpose or special-purpose computer system. Computer-readable media that store computer-executable instructions in the form of data are one or more “physical computer storage media” or “hardware storage device(s).” Computer-readable media that merely carry computer-executable instructions without storing the computer-executable instructions are “transmission media.” Thus, by way of example and not limitation, the current embodiments can comprise at least two distinctly different kinds of computer-readable media: computer storage media and transmission media.

Computer storage media (aka “hardware storage device”) are computer-readable recording media, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in hardware in the form of computer-executable instructions, data, or data structures and that can be accessed by a general-purpose or special-purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmission media can include a network and/or data links which can be used to carry program code in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general-purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Disclosed embodiments may comprise or utilize cloud computing. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Those skilled in the art will appreciate that at least some aspects of the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, wearable devices, and the like. The invention may also be practiced in distributed system environments where multiple computer systems (e.g., local and remote systems), which are linked through a network (either by hardwired data links, wireless data links, or by a combination of hardwired and wireless data links), perform tasks. In a distributed system environment, program modules may be located in local and/or remote memory storage devices.

Alternatively, or in addition, at least some of the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Application-specific Standard Products (ASSPs), System-on-a-chip systems (SOCs), Complex Programmable Logic Devices (CPLDs), central processing units (CPUs), graphics processing units (GPUs), and/or others.

As used herein, the terms “executable module,” “executable component,” “component,” “module,” or “engine” can refer to hardware processing units or to software objects, routines, or methods that may be executed on one or more computer systems. The different components, modules, engines, and services described herein may be implemented as objects or processors that execute on one or more computer systems (e.g., as separate threads).

One will also appreciate how any feature or operation disclosed herein may be combined with any one or combination of the other features and operations disclosed herein. Additionally, the content or feature in any one of the figures may be combined or used in connection with any content or feature used in any of the other figures. In this regard, the content disclosed in any one figure is not mutually exclusive and instead may be combinable with the content from any of the other figures.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for facilitating detection of defects in materials, comprising:
one or more processors; and
one or more computer-readable recording media that store instructions that are executable by the one or more processors to configure the system to:
access a training dataset comprising a plurality of cross-sectional images providing a nominal representation of a component; and
train an off-nominal anomaly detection model using the training dataset by:
for each particular cross-sectional image of the plurality of cross-sectional images:
generate a set of patch embedding vectors comprising a patch embedding vector for each image patch of the particular cross-sectional image; and
generate a probabilistic representation of a nominal component using the set of patch embedding vectors.

2. The system of claim 1, wherein the plurality of cross-sectional images comprises a plurality of computed tomography (CT) images.

3. The system of claim 1, wherein the plurality of cross-sectional images comprises cross-sectional images selected or sampled from an initial set of cross-sectional images of the component.

4. The system of claim 3, wherein the plurality of cross-sectional images omits one or more cross-sectional images from the initial set of cross-sectional images that show one or more defects.

5. The system of claim 3, wherein the initial set of cross-sectional images includes a plurality of subsets of cross-sectional images, wherein each of the plurality of subsets of cross-sectional images depicts a different copy or instance of the component.

6. The system of claim 5, wherein the plurality of cross-sectional images includes cross-sectional images from at least two subsets of cross-sectional images from the plurality of subsets of cross-sectional images.

7. The system of claim 1, wherein the plurality of cross-sectional images provides the nominal representation of the component according to a first axis, and wherein the off-nominal anomaly detection model is associated with the first axis, and wherein the instructions are executable by the one or more processors to configure the system to:
access a second training dataset comprising a plurality of second cross-sectional images providing a second nominal representation of the component according to a second axis; and
train a second off-nominal anomaly detection model associated with the second axis using the second training dataset by:
for each particular second cross-sectional image of the plurality of second cross-sectional images:
generate a set of second patch embedding vectors comprising a second patch embedding vector for each second image patch of the particular second cross-sectional image; and
generate a second probabilistic representation of the nominal component using the set of second patch embedding vectors.

8. A system for facilitating detection of defects in materials, comprising:
one or more processors; and
one or more computer-readable recording media that store instructions that are executable by the one or more processors to configure the system to:
access a set of input images comprising a plurality of cross-sectional images providing a representation of a component; and
process the set of input images using an off-nominal anomaly detection model by, for each particular cross-sectional image of the plurality of cross-sectional images:
generate a set of patch embedding vectors comprising a patch embedding vector for each image patch of the particular cross-sectional image;
generate a set of difference metrics based on the set of patch embedding vectors and a probabilistic representation of a nominal component; and
determine a set of anomaly scores for the particular cross-sectional image based on the set of difference metrics.

9. The system of claim 8, wherein the plurality of cross-sectional images comprises a plurality of computed tomography (CT) images.

10. The system of claim 8, wherein the set of anomaly scores for the particular cross-sectional image comprises a respective patch anomaly score for each image patch of the particular cross-sectional image.

11. The system of claim 8, wherein the set of anomaly scores for the particular cross-sectional image comprises an overall anomaly score based on one or more respective patch anomaly scores for each image patch of the particular cross-sectional image.

12. The system of claim 8, wherein the instructions are executable by the one or more processors to configure the system to:
for each particular cross-sectional image of the plurality of cross-sectional images, generate a heat map using the set of anomaly scores.

13. The system of claim 8, wherein the instructions are executable by the one or more processors to configure the system to:
generate a 3D representation of the component using the plurality of cross-sectional images and the set of anomaly scores.

14. The system of claim 8, wherein the plurality of cross-sectional images provides the representation of the component according to a first axis, and wherein the off-nominal anomaly detection model is associated with the first axis, and wherein the instructions are executable by the one or more processors to configure the system to:
access a second set of input images comprising a plurality of second cross-sectional images that provides a second representation of the component according to a second axis; and
process the second set of input images using a second off-nominal anomaly detection model associated with the second axis by, for each particular second cross-sectional image of the plurality of second cross-sectional images:
generate a set of second patch embedding vectors comprising a second patch embedding vector for each second image patch of the particular second cross-sectional image;
generate a set of second difference metrics based on the set of second patch embedding vectors and a second probabilistic representation of the nominal component; and
determine a set of second anomaly scores for the particular second cross-sectional image based on the set of second difference metrics.

15. The system of claim 8, wherein the instructions are executable by the one or more processors to configure the system to:
present a user interface frontend that lists one or more flagged images from the set of input images, wherein each of the one or more flagged images is associated a respective set of anomaly scores that satisfies one or more conditions.

16. The system of claim 15, wherein the one or more conditions comprise the respective set of anomaly scores including one or more overall anomaly scores or one or more patch anomaly scores that satisfy one or more thresholds.

17. The system of claim 15, wherein the user interface frontend is configured to receive user input indicating whether a selected flagged image depicts one or more defects.

18. The system of claim 17, wherein the instructions are executable by the one or more processors to configure the system to:
further train the off-nominal anomaly detection model based on user input indicating whether a selected flagged image depicts one or more defects.

19. The system of claim 15, wherein the user interface frontend is configured to receive user input classifying one or more defects present in a selected flagged image.

20. A method for facilitating detection of defects in materials, comprising:
accessing a set of input images comprising a plurality of cross-sectional images providing a representation of a component; and
processing the set of input images using an off-nominal anomaly detection model by, for each particular cross-sectional image of the plurality of cross-sectional images:
generating a set of patch embedding vectors comprising a patch embedding vector for each image patch of the particular cross-sectional image;
generating a set of difference metrics based on the set of patch embedding vectors and a probabilistic representation of a nominal component; and
determining a set of anomaly scores for the particular cross-sectional image based on the set of difference metrics.
